(19) United States
(12) Patent Application Publication
(10) Pub. No.: US 2010/0143668 A1
(43) Pub. Date: Jun. 10, 2010

(54) METHOD AND APPARATUS FOR MANUFACTURING A COMPONENT FROM A COMPOSITE MATERIAL

(76) Inventors: Benjamin Lionel Farmer, Bristol (GB); Daniel Mark Johns, Bristol (GB)

Correspondence Address: NIXON & VANDERHYE, PC, 901 NORTH GLEBE ROAD, 11TH FLOOR, ARLINGTON, VA, 22203, US

(21) Appl. No.: 12/733,181

(22) PCT Filed: Aug. 8, 2008
(86) PCT No.: PCT/GB2008/050682

§ 371 Date: Feb. 16, 2010

(30) Foreign Application Priority Data
Aug. 16, 2007 (GB) 0715990.8

(51) Int. Cl. B05D 3/06; H01F 1/11; B32B 3/10; B05B 5/00

(52) U.S. Cl. 428/195.1; 427/547; 427/550; 118/640; 252/62.51 R; 977/742; 977/842

(57) ABSTRACT

A method of manufacturing a component from a composite material, the composite material comprising a matrix and a plurality of reinforcement elements (CNTs), the method comprising: forming a series of layers of the composite material, each layer being formed on top of a previous layer; and applying an electromagnetic field to the composite material before the next layer is formed on top of it, the electromagnetic field causing at least some of the reinforcement elements to rotate. An apparatus comprising a build platform, a system for forming a series of layers of composite materials on the build platform and an electrode for applying an electromagnetic field is also disclosed. A composite powder comprising CNTs and a matrix and the method of fabrication are disclosed as a second aspect of the application.

### FIELD OF THE INVENTION

The present invention relates to a method and apparatus for manufacturing a component from a composite material.

### BACKGROUND OF THE INVENTION

The use of electromagnetic fields to align carbon nanotubes (CNTs) in a liquid composite matrix is known. See for example “Aligned Single Wall Carbon Nanotube Polymer Composites Using an Electric Field” C. Park, J. Wilkinson, S. Banda, Z. Ounaies, K. E. Wise, G. Sauti, P. T. Lillehei, J. S. Harrison, Journal of Polymer Science Part B: Polymer Physics 2006, 44, 1751-1762. In this article an AC field is applied at various strengths and frequencies.

A problem with such techniques is that the field can only align the CNTs in a relatively thin layer. The alignment of CNTs throughout a bulk material is not possible since the viscosity of the composite matrix must be overcome throughout the volume using a field of sufficient strength.

### SUMMARY OF THE INVENTION

A first aspect of the invention provides a method of additively manufacturing a component from a composite material, the composite material comprising a matrix and a plurality of reinforcement elements, the method comprising:
forming a series of layers of the composite material, each layer being formed on top of a previous layer; and
applying an electromagnetic field to the composite material before the next layer is formed on top of it, the electromagnetic field causing at least some of the reinforcement elements to rotate.

Each layer may be consolidated and/or cured by directing energy to selected parts of the layer before the next layer is formed on top of it. For instance in the “powder bed” arrangement of the preferred embodiment of the invention the composite material comprises a powder, each powder particle comprising a plurality of reinforcement elements contained within a matrix; and the energy consolidates selected parts of each layer by melting the matrix. In this case the electromagnetic field causes at least some of the powder particles to rotate.

Typically the composite material is agitated as the electromagnetic field is applied, for instance by stirring or ultrasonic agitation.

The reinforcement elements may be aligned before the electromagnetic field is applied, and in this case the elements may rotate together. For instance the field may cause them rotate together from a perpendicular orientation to an angled orientation. However preferably at least some of the elements rotate with respect to each other, for instance to become co-aligned from a disordered state.

The properties of the component may be controlled by applying different electromagnetic fields to at least two of the layers. For instance the orientation, pattern, strength, and/or frequency of the applied field may be varied between layers.

Typically the method further comprising forming at least two of the layers with different shapes, sizes or patterns. This enables a component to be formed in a so-called “net shape” by forming each layer under control of a computer model of the desired net-shape.

The reinforcement elements typically have an elongate structure such as tubes, fibres or plates. The reinforcement elements may be solid or tubular. For instance the reinforcement elements may comprise single walled carbon nanotubes (CNTs); multi-walled CNTs, carbon nanofibres; or CNTs coated with a layer of amorphous carbon or metal.

Typically at least one of the reinforcement elements have an aspect ratio greater than 100, preferably greater than 1000, and most preferably greater than 10⁶.

The reinforcement elements may be formed of any material such as silicon carbide or alumina, but preferably the reinforcement elements are formed from carbon. This is preferred due to the strength and stiffness of the carbon-carbon bond and the electrical properties found in carbon materials.

A second aspect of the invention provides apparatus for additively manufacturing a component from a composite material, the composite material comprising a matrix and a plurality of reinforcement elements, the method comprising:
a build platform;
a system for forming a series of layers of composite material on the build platform, each layer being formed on top of a previous layer; and
an electrode for applying an electromagnetic field to the composite material before the next layer is formed on top of it, the electromagnetic field causing at least some of the reinforcement elements to rotate

A third aspect of the invention provides a composite powder, each powder particle comprising a plurality of reinforcement elements contained within a matrix.

A fourth aspect of the invention provides a method of manufacturing a composite powder, the method comprising chopping a fibre into a series of lengths, each length constituting a powder particle, the fibre comprising a plurality of reinforcement elements contained within a matrix.

Typically the reinforcement elements in the fibre are at least partially aligned with each other.

### BRIEF DESCRIPTION OF THE DRAWINGS

Embodiments of the invention will now be described with reference to the accompanying drawings, in which:

FIG. 1 is a cross-sectional view of a fibre;

FIG. 2 shows the fibre chopped into a series of lengths

FIG. 3 shows a layer of polymer powder with particles randomly aligned in three dimensions;

FIG. 4 shows a powder bed additive manufacturing system;

FIG. 5 shows the layer being aligned by an electromagnetic field;

FIG. 6 shows an energy source melting the polymer powder into a consolidated layer; and

FIG. 7 shows a three layer component.

### DETAILED DESCRIPTION OF EMBODIMENT(S)

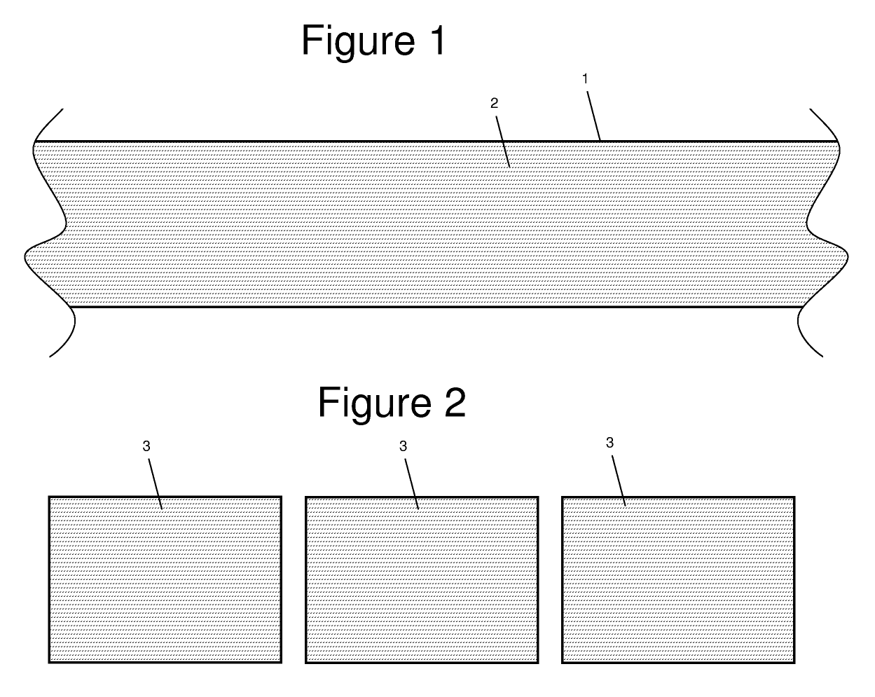

FIG. 1 shows part of the length of a fibre 1. The fibre 1 comprises a plurality of single-walled carbon nanotubes (SWNTs) 2 contained within a polymer matrix. The SWNTs 2 are aligned parallel with the length of the fibre 1.

The fibre 1 may be formed in a number of ways, including electrospinning and melt spinning. In the case of electrospinning the fibre 1 is drawn out from a viscous polymer solution by applying an electric field to a droplet of the solution (most often at a metallic needle tip). The solution contains randomly aligned SWNTs, but the SWNTs become at least partially aligned during the electrospinning process. See for example:
CHARACTERISTICS OF ELECTROSPUN CARBON NANOTUBE-POLYMER COMPOSITES; Heidi Schreuder-Gibson, Kris Senecal, Michael Sennett, Zhongping Huang, JianGuo Wen, Wenzhi Li, Dezhi Wangl, Shaoxian Yang, Yi Tul, Zhifeng Ren & Changmo Sung, available online at: http://lib.store.yahoo.net/lib/nanolab2000/Composites.pdf
Synopsis of the thesis entitled PREPARATION AND ELECTRICAL CHARACTERIZATION OF ELECTROSPUN FIBERS OF CARBON NANOTUBE-POLYMER NANOCOMPOSITES, BIBEKANANDA SUNDARAY, available online at: http://www.physics.iitm.ac.in/research_files/synopsis/bibek.pdf

The fibre 1 is then chopped into a series of short lengths 3 as shown in FIG. 2, each length 3 constituting a powder particle.

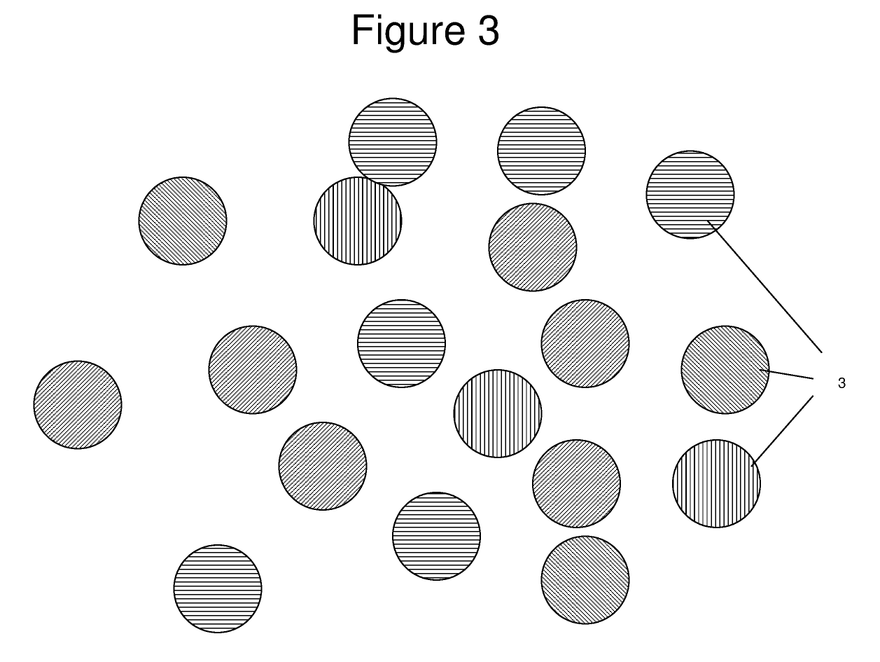

The powder can then be used as a feedstock in a powder-bed additive manufacturing process as shown in FIGS. 3-6. Note that the powder particles 3 are shown schematically in FIGS. 3-6 as spheres instead of elongate cylinders for ease of illustration.

As shown in FIG. 3, the powder particles 3 are initially randomly aligned in three dimensions.

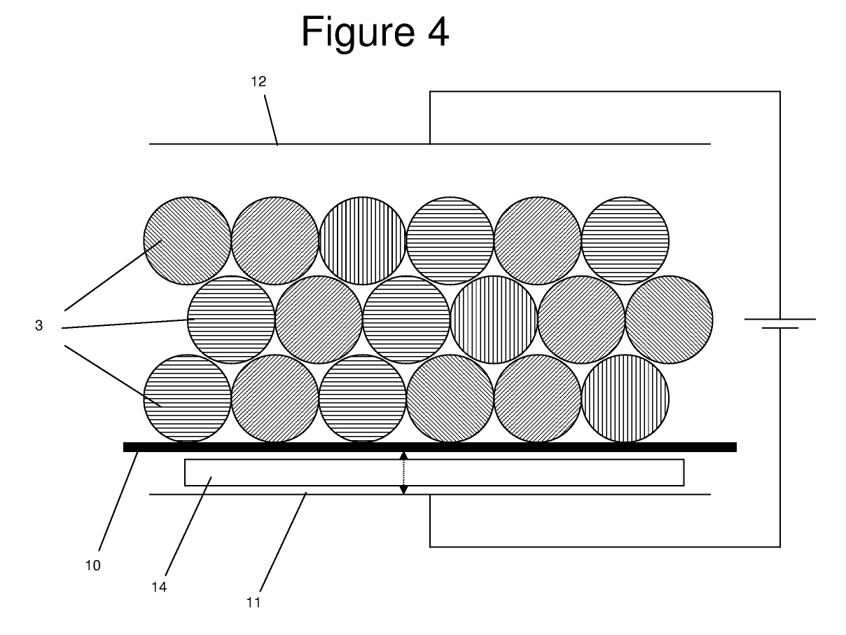

FIG. 4 shows a powder bed additive manufacturing system. A roller (not shown) picks up powder feedstock from one of a pair of feed containers (not shown) and rolls a continuous bed of powder over a build platform 10. The roller imparts a degree of packing between adjacent polymer powder particles, as shown in FIG. 4.

Incorporated into the additive layer manufacturing system is a source of a strong electromagnetic field (i.e. electrodes 11,12) and a source of ultrasonic agitation, such as an ultrasonic horn 14.

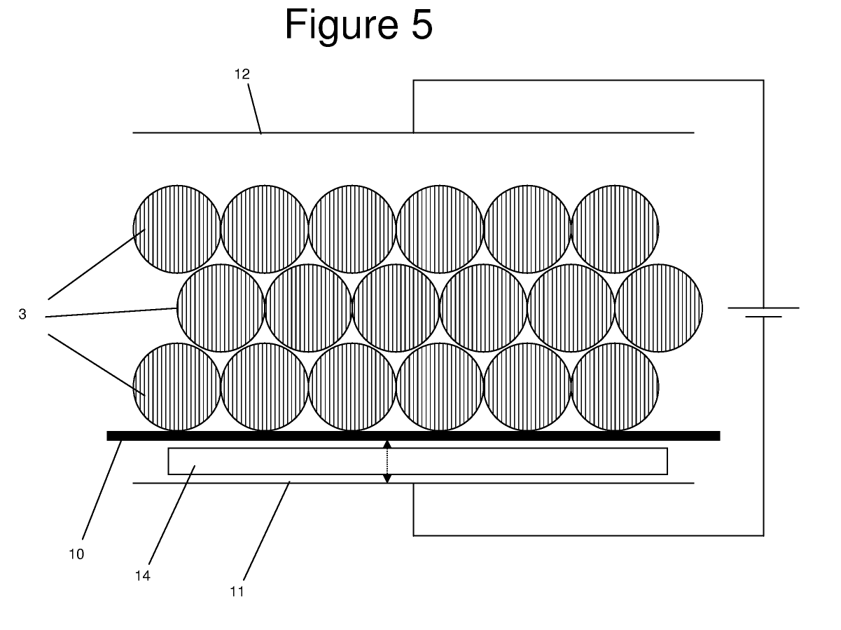

Under ultrasonic agitation the particles 3 are free to rotate around their own axis, which once the electromagnetic field is applied, causes the particles to rotate and line up with each other in the direction of the field as shown in FIG. 5.

Various forms of electromagnetic field may be applied. For instance the field may be direct current (DC) or alternating current (AC). The electric or magnetic component may be dominant. Examples of suitable fields are described in:
http://www.trnmag.com/Stories/2004/042104/Magnets_align_nanotubes_in_resin_Brief_{—}042104.html. This article describes a process in which single-walled nanotubes were mixed with thixotropic resin. When the mix was exposed to magnetic fields larger than 15 Tesla the nanotubes lined up in the direction of the field.
“Aligned Single Wall Carbon Nanotube Polymer Composites Using an Electric Field” C. Park, J. Wilkinson, S. Banda, Z. Ounaies, K. E. Wise, G. Sauti, P. T. Lillehei, J. S. Harrison, Journal of Polymer Science Part B: Polymer Physics 2006, 44, 1751-1762. In this article an AC field is applied at various strengths and frequencies to align the CNTs.

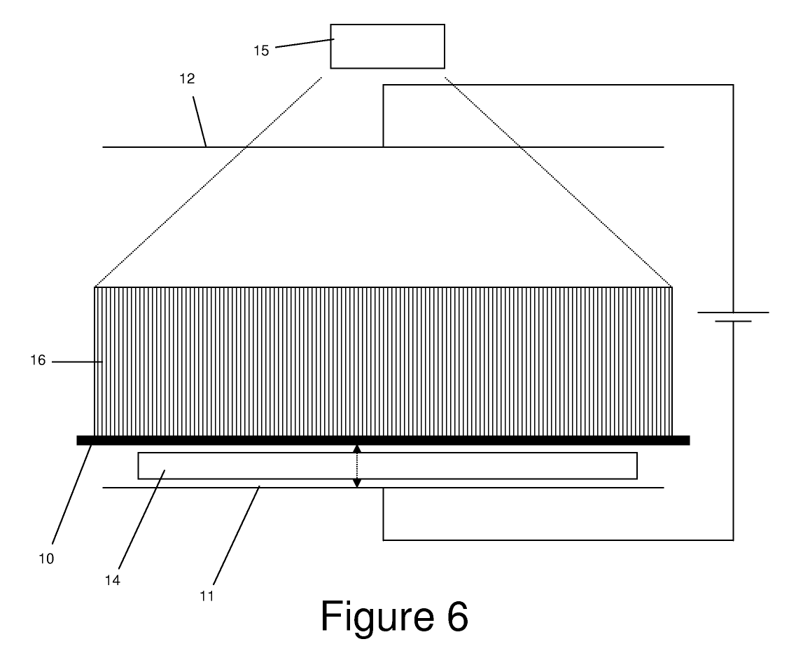

With the field remaining on, a heat source 15 shown in FIG. 6 is then turned on to melt the polymer matrix material and form a consolidated layer 16, whilst maintaining the global orientation of the CNTs. The heat source 15 may for instance be a laser which scans a laser beam across the build platform and directs energy to selected parts of the bed. The heat melts and consolidates the selected parts of the bed, and any un-melted powder can be removed after the process is complete.

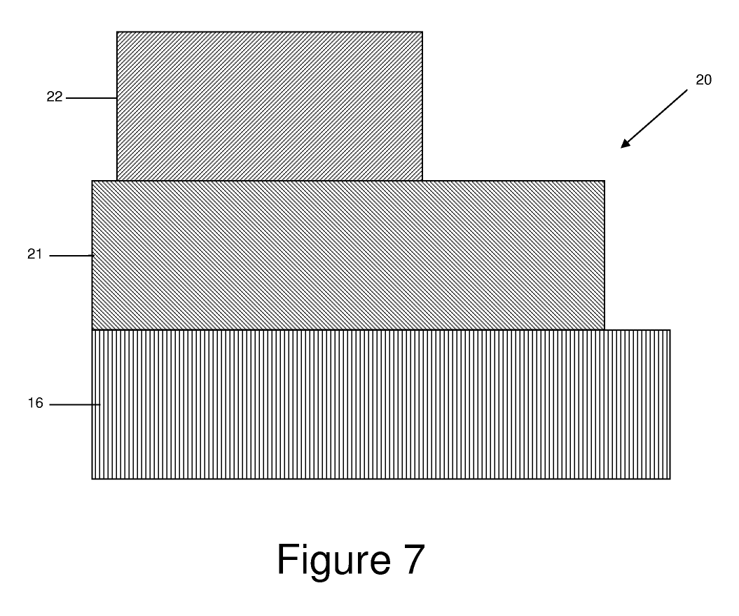

The process then repeats to form a component 20 with a series of layers 16,21,22 shown in FIG. 7. The laser beam is scanned and modulated under control of a computer model to form each individual layer with a desired net-shape. Note that the CNTs in each layer 16,21 are aligned before the next layer is formed on top of it. By aligning the CNTs in such a progressive or serial manner (instead of attempting to align all of the CNTs in all layers at the same time) only a relatively small amount of energy is required to achieve the desired degree of alignment.

Note that the properties of the component may be controlled by applying different electromagnetic fields to the feedstock in at least two of the layers. For instance in FIG. 7 the SWNTs are aligned at 90° to the build platform in layer 16, at −45° to the build platform in layer 21, and at +45° to the build platform in layer 22. As well as varying its orientation, the pattern, strength or frequency of the applied field may also be varied between layers.

Although the invention has been described above with reference to one or more preferred embodiments, it will be appreciated that various changes or modifications may be made without departing from the scope of the invention as defined in the appended claims.

For instance in a first alternative arrangement the composite material may comprise a photo-curing liquid contained in a vat. The vat contains a build platform which is lifted up slightly above the surface of the liquid to form a thin layer of liquid. The thin layer is then exposed to the electromagnetic field to rotate the reinforcement elements. The thin layer is then scanned with a laser in a selected pattern to selectively cure the liquid.

In a second alternative arrangement the composite material may be deposited from a feed head to selected parts of a build region. An example of such a process is a so-called “powder feed” process in which powder feedstock is emitted from a nozzle, and melted as it exits the nozzle. The nozzle is scanned across a build platform and the stream of molten powder is turned on and off as required. In this case the reinforcement elements may be rotated as they exit the feed head, or on the build platform after they have been deposited. Note that in common with the methods described above the component is built up in a series of layers, but in this case the layers may be non-planar and/or non-horizontal.

1. A method of additively manufacturing a component from a composite material, the composite material comprising a matrix and a plurality of reinforcement elements, the method comprising:
forming a series of layers of the composite material, each layer being formed on top of a previous layer; and
applying an electromagnetic field to the composite material before the next layer is formed on top of it, the electromagnetic field causing at least some of the reinforcement elements to rotate.

2. The method of claim 1 further comprising directing energy to selected parts of each layer before the next layer is formed on top of it, the energy curing and/or consolidating the selected parts of each layer.

3. The method of claim 2, wherein the composite material comprises a powder, each powder particle comprising a plurality of reinforcement elements contained within a matrix; and wherein the energy consolidates selected parts of a bed of powder by melting the matrix.

4. The method of claim 3 wherein the electromagnetic field causes at least some of the powder particles to rotate.

5. The method of claim 1 further comprising agitating the composite material as the electromagnetic field is applied.

6. The method of claim 5 wherein the composite material is agitated ultrasonically.

7. The method of claim 1 wherein at least some of the reinforcement elements rotate with respect to each other.

8. The method of claim 1 further comprising applying different electromagnetic fields to at least two of the layers.

9. The method of claim 1 further comprising forming at least two of the layers with different shapes, sizes or patterns.

10. The method of claim 1 wherein the reinforcement elements comprise carbon nanotubes or carbon nanofibres.

11. The method of claim 1 wherein the reinforcement elements comprise single-walled carbon nanotubes.

12. A composite component manufactured by the method of claim 1.

13. Apparatus for additively manufacturing a component from a composite material, the composite material comprising a matrix and a plurality of reinforcement elements, the method comprising:
a build platform;
a system for forming a series of layers of composite material on the build platform, each layer being formed on top of a previous layer; and
an electrode for applying an electromagnetic field to the composite material before the next layer is formed on top of it, the electromagnetic field causing at least some of the reinforcement elements to rotate

14. A composite powder, each powder particle comprising a plurality of reinforcement elements contained within a matrix.

15. The powder of claim 14, wherein the reinforcement elements comprise carbon nanotubes or carbon nanofibres.

16. The powder of claim 14 wherein the reinforcement elements comprise single-walled carbon nanotubes.

17. The powder of claim 14, wherein the reinforcement elements within each powder particle are at least partially aligned with each other.

18. A method of manufacturing a composite powder, the method comprising chopping a fibre into a series of lengths, each length constituting a powder particle, the fibre comprising a plurality of reinforcement elements contained within a matrix.

19. The method of claim 18 wherein the reinforcement elements in the fibre are at least partially aligned with each other.
